(19) United States
(12) Patent Application Publication
(10) Pub. No.: US 2018/0347637 A1
(43) Pub. Date: Dec. 6, 2018

(54) Pinion Flange With Dampening Member

(71) Applicant: GM GLOBAL TECHNOLOGY OPERATIONS LLC, Detroit, MI (US)

(72) Inventor: Shaun X. Zhao, Novi, MI (US)

(21) Appl. No.: 15/609,623

(22) Filed: May 31, 2017

(51) Int. Cl. F16D 3/70; F16D 3/12

(52) U.S. Cl. CPC F16D 3/70; F16D 2250/0084; F16D 3/12

(57) ABSTRACT

A pinion flange having built-in dampening is disclosed. The pinion flange includes at least one opening through which a ring-shaped damper extends. A ring-shaped support member fits within the opening such that the damper is between the edge surface of the opening in the flange and the support member. A mechanical fastener extends through the opening to connect the pinion flange to other components of the vehicle driveline.

### INTRODUCTION

The present invention relates generally to the field of vehicles and, more specifically, to a pinion flange with built-in damping characteristics for a driveline assembly.

Drive shafts, such as prop shafts and half shafts are used in automobiles and other applications to transfer rotational motion in a driveline from one component to another, such as from a transmission to a wheel. Flange joints are used to join the drive shaft to a part of the driveline such as a CV joint.

Typically, a driveline assembly includes a pinion flange and a separate damping member to reduce the effects of noise and vibration. However, the additional damping adds cost and complexity to the driveline assembly.

### SUMMARY

Embodiments according to the present disclosure provide a number of advantages. For example, embodiments according to the present disclosure enables a reduction of components and eliminates manufacturing and assembly steps.

In one aspect, a pinion flange assembly includes a body having a first flange surface and a second flange surface opposite the first flange surface, at least one edge in the first flange surface defining at least one opening through the body and connecting the first and second flange surfaces, a damper member having a ring shape and configured to fit within the at least one opening, and a support member having a ring shape and configured to fit within the ring-shaped damper member, the support member providing support for at least one fastening member. The damper member is sandwiched between the at least one edge and the support member such that force transferred from the at least one fastening member to the flange body is attenuated by the damper member.

In some aspects, the support member has a smaller diameter than the damper member.

In some aspects, the damper member comprises a flexible material and the support member comprises a rigid material.

In some aspects, the damper member is rubber and the support member is metal.

In some aspects, the damper member has a first face adjacent and coplanar with the first flange surface.

In some aspects, the support member has a first face adjacent to and coplanar to the first face of the damper member.

In another aspect, an automotive vehicle includes a shaft configured to transfer rotational motion and a pinion flange coupled to the shaft. The pinion flange includes a flange body having at least one opening defined by an edge surface, a damper member, and a support member. The damper member is sandwiched between the edge surface and the support member such that the damper member attenuates vibrations transmitted through the shaft.

In some aspects, the support member has a smaller diameter than the damping member.

In some aspects, the damper member comprises a flexible material and the support member comprises a rigid material.

In some aspects, the damper member has a first face adjacent and coplanar with the edge surface.

In some aspects, the support member has a first face adjacent to and coplanar with the first face of the damper member.

In some aspects, the damper member and the support member each define openings that are generally coaxial with the at least one opening in the flange body.

In yet another aspect, a method of assembling a pinion flange for an automotive vehicle includes the steps of forming a first opening in the pinion flange, pressing a ring-shaped damper member into the first opening such that the damper member defines a second opening, and pressing a ring-shaped support member into the second opening such that the damper member is adjacent to and between the support member and the first opening in the pinion flange.

### BRIEF DESCRIPTION OF THE DRAWINGS

The present disclosure will be described in conjunction with the following figures, wherein like numerals denote like elements.

FIG. 1 is a bottom view of a vehicle, according to an embodiment.

FIG. 2 is a schematic diagram of a pinion flange having built-in dampers, according to an embodiment.

FIG. 3 is a schematic diagram of a pinion flange having built-in dampers, according to another embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A pinion flange in an exemplary embodiment includes at least one built-in damper. The built in dampers are located at the connection points or bolt holes where bolts or other mechanical fasteners connect the pinion flange to other components of the driveline. For some applications, the built-in dampers eliminate an additional dampening member in the driveline assembly, reducing manufacturing complexity and also reducing driveline mass and cost.

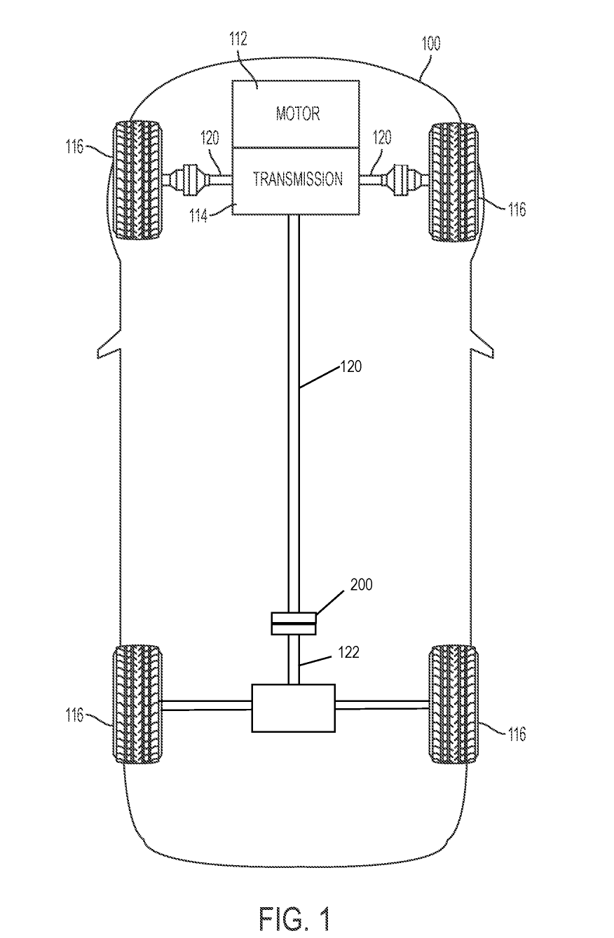

FIG. 1 shows an exemplary vehicle 100 including a motor 112, a transmission 114, and wheels 116. In the exemplary embodiment transmission 114 drives wheels 116 using a drive shaft 120 and a flange joint 200. Vehicle 100 is shown in the exemplary embodiment as a passenger automobile, truck, or SUV. In other embodiments vehicle 100 may be other types of vehicles such as motorcycles, airplanes, boats, and other vehicles that use or can be made to use a flange joint for translating torque. Motor 112 may be any type of motor or engine such as an internal combustion engine, or an electric motor. Transmission 114 may be used to translate power from the engine to wheels 116. In alternative embodiments a transmission may not be useful where a motor or engine is suitable for driving wheels 116 without the use of a transmission. A flange joint according to an exemplary embodiment allows a smaller flange joint to be used to deliver the same amount of torque as conventional flange joints, thereby saving costs in material and weight in the driveline.

Drive shaft 120, such as a prop shaft or a half shaft may be used as part of a driveline to drive wheels 116 with power from motor 112. Drive shaft 120 may be coupled to a flange joint 200 which may be part of a CV joint or other type of joint. In exemplary embodiments, such as when the vehicle 100 is an SUV or truck, the pinion flange 200 connects the drive shaft 120 and a pinion shaft 122.

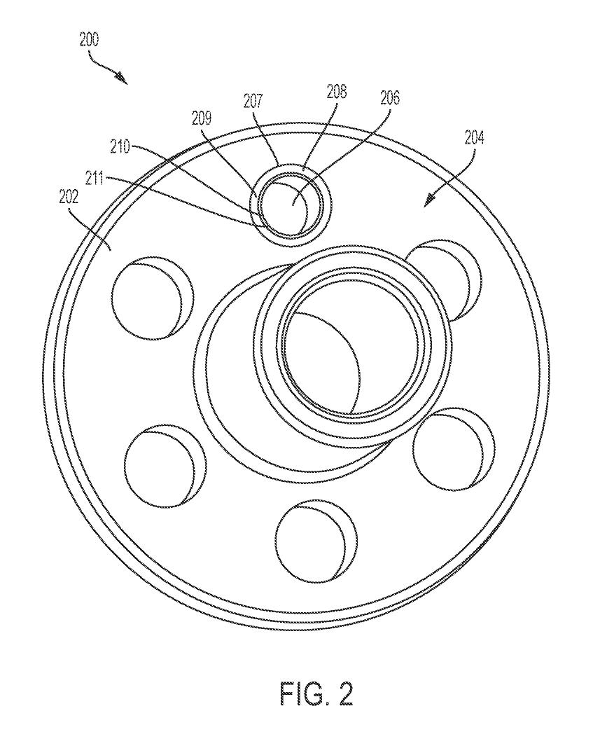

With reference to FIG. 2, in one embodiment, a pinion flange 200 includes a flange body 202. The flange body 202 includes a flange surface 204. At least one opening or mounting hole 206 is formed in the flange surface 204. The opening 206 in the flange 200 is defined by an edge surface 207 formed in the flange body 202 such that the opening 206 extends through the flange body 202 from a front side or first surface 204 to a back side or second surface (not shown). FIG. 2 illustrates six openings 206; however, as may be appreciated, other embodiments may include more or fewer openings 206.

Each opening 206 includes a damper 208. In some embodiments, the damper 208 is a ring of dampening material, such as rubber, for example and without limitation. The damper 208 fits tightly within the opening 206 such that an exterior edge of the damper 208 is adjacent to the edge surface 207. The damper 208 extends at least partially through the opening 206 such that a first surface or face 209 of the damper 208 is adjacent to the flange surface 204 and a second surface or face (not shown) of the damper 208 is adjacent to the opposite or back surface (not shown) of the flange body 202.

Each opening 206 also includes a ring 210. The ring 210 is adjacent to the inner surface of the damper 208 such that the damper 208 is sandwiched between the ring 210 and the edge 207 of the opening 206. In some embodiments, the ring 210 has a smaller diameter than the damper 208. In some embodiments, the ring 210 is a metal or other rigid member inserted into the opening 206 to provide rigidity for the bolts or other fasteners used to connect the pinion flange 200 to other driveline components. The ring 210 extends at least partially through the opening 206 such that a first surface or face 211 of the ring 210 is adjacent to the first surface or face 209 of the damper 208 and a second surface or face (not shown) of the ring 210 is adjacent to the second surface or face (not shown) of the damper 208. In some embodiments, the first surface or face of the ring 210, the first surface 209 of the damper 208 and the flange surface 204 are approximately coplanar, and similarly, the second surface of the ring 210, the second surface of the damper 208, and the back surface of the flange body 202 are approximately coplanar. In some embodiments, the first surface or face of the ring 210, the first surface 209 of the damper 208 and the flange surface 204 are approximately coplanar while the second surface of the ring 210, the second surface of the damper 208, and the back surface of the flange body 202 are not coplanar, and vice versa. In some embodiments, the opening 206, the opening in the damper 208, and the opening in the ring 210 are generally coaxial.

The ring 210 provides a rigid surface for the mechanical fastener used to connect the flange 200 to the other driveline components. The damper 208 attenuates vibrations or other movement of the driveline and dampens the effect of the vibrations on other driveline components.

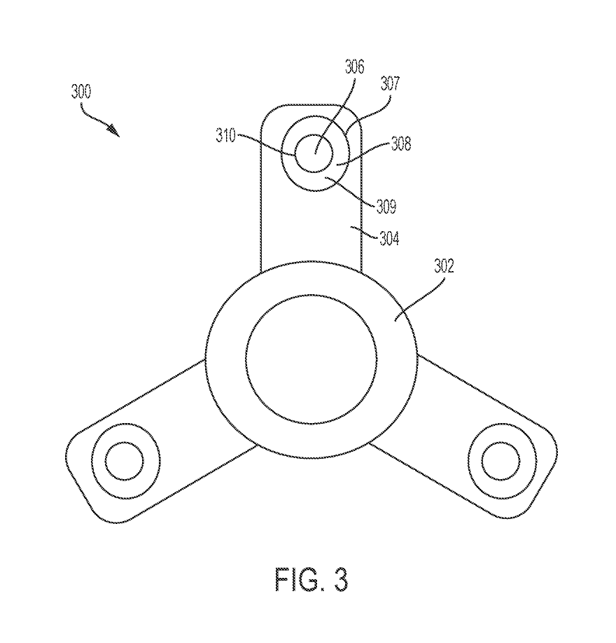

With reference to FIG. 3, in one embodiment, a pinion flange 300 includes a flange body 302. The flange body 302 includes at least one flange surface 304. FIG. 3 illustrates three flange surfaces 304; however, as may be appreciated, other embodiments may include more or fewer flange surfaces 304.

At least one opening or mounting hole 306 is formed in the flange surface 304. The opening 306 in the pinion flange 300 is defined by an edge surface 307 formed in the flange body 302 such that the opening 306 extends through the flange body 302 from a front side or first flange surface 304 to a back side or second surface (not shown). FIG. 3 illustrates three openings 306 in each of the flange surfaces 304; however, as may be appreciated, other embodiments may include more or fewer openings 306.

Each opening 306 includes a damper 308. In some embodiments, the damper 308 is a ring of dampening material, such as rubber, for example and without limitation. The damper 308 fits tightly within the opening 306 such that an exterior edge of the damper 308 is adjacent to the edge surface 307. The damper 308 extends at least partially through the opening 306 such that a first surface or face 309 of the damper 308 is adjacent to the flange surface 304 and a second surface or face (not shown) of the damper 308 is adjacent to the opposite or back surface (not shown) of the flange body 302.

Each opening 306 also includes a ring 310. The ring 310 is adjacent to the inner surface of the damper 308 such that the damper 308 is sandwiched between the ring 310 and the edge 307 of the opening 306. In some embodiments, the ring 310 has a smaller diameter than the damper 308. In some embodiments, the ring 310 is a metal or other rigid member inserted into the opening 306 to provide rigidity for the bolts or other fasteners used to connect the pinion flange 300 to other driveline components. The ring 310 extends at least partially through the opening 306 such that a first surface or face of the ring 310 is adjacent to the first surface or face 309 of the damper 308 and a second surface or face (not shown) of the ring 310 is adjacent to the second surface or face (not shown) of the damper 308. In some embodiments, the first surface or face of the ring 310, the first surface 309 of the damper 308 and the flange surface 304 are approximately coplanar, and similarly, the second surface of the ring 310, the second surface of the damper 308, and the back surface of the flange body 302 are approximately coplanar. In some embodiments, the first surface or face of the ring 310, the first surface 309 of the damper 308 and the flange surface 304 are approximately coplanar while the second surface of the ring 310, the second surface of the damper 308, and the back surface of the flange body 302 are not coplanar, and vice versa.

Similar to the ring 210 discussed herein, the ring 310 provides a rigid surface for the mechanical fastener used to connect the flange 300 to the other driveline components. The damper 308 attenuates vibrations or other movement of the driveline and dampens the effect of the vibrations on other driveline components.

In some embodiments, the flanges 200, 300 are manufactured by machining or casting the flange body 202, 302. In some embodiments, the openings 206, 306 are machined or otherwise formed in the flange body 202, 302. The dampers 208, 308 and the rings 210, 310 are pressfit or otherwise inserted into the openings 206, 306. In some embodiments, the dampers 208, 308 and the rings 210, 310 are pressfit into a single piece that is then pressfit into the openings 206, 306 in the flanges 200, 300. In some embodiments, the dampers 208, 308 are first pressfit or otherwise inserted into the openings 206, 306 and, in a separate step, the rings 210, 310 are pressfit or otherwise inserted into the openings 206, 306 such that the rings 210, 310 are adjacent to the dampers 208, 308 and the rings 210, 310 define the inner surface of the openings 206, 306.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof and words of similar import.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantifies, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context dearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A pinion flange assembly, comprising:
a body having a first flange surface and a second flange surface opposite the first flange surface, at least one edge in the first flange surface defining at least one opening through the body and connecting the first and second flange surfaces;
a damper member having a ring shape and configured to fit within the at least one opening; and
a support member having a ring shape and configured to fit within the ring-shaped damper member, the support member providing support for at least one fastening member;
wherein the damper member is sandwiched between the at least one edge and the support member such that force transferred from the at least one fastening member to the flange body is attenuated by the damper member.

2. The pinion flange assembly of claim 1, wherein the support member has a smaller diameter than the damper member.

3. The pinion flange assembly of claim 1, wherein the damper member comprises a flexible material and the support member comprises a rigid material.

4. The pinion flange assembly of claim 1, wherein the damper member is rubber and the support member is metal.

5. The pinon flange assembly of claim 1, wherein the damper member has a first face adjacent and coplanar with the first flange surface.

6. The pinion flange assembly of claim 5, wherein the support member has a first face adjacent to and coplanar to the first face of the damper member.

7. An automotive vehicle, comprising:
a shaft configured to transfer rotational motion;
a pinion flange coupled to the shaft, the pinion flange comprising
a flange body having at least one opening defined by an edge surface;
a damper member; and
a support member;
wherein the damper member is sandwiched between the edge surface and the support member such that the damper member attenuates vibrations transmitted through the shaft.

8. The automotive vehicle of claim 7, wherein the support member has a smaller diameter than the damping member.

9. The automotive vehicle of claim 8, wherein the damper member comprises a flexible material and the support member comprises a rigid material.

10. The automotive vehicle of claim 8, wherein the damper member has a first face adjacent and coplanar with the edge surface.

11. The automotive vehicle of claim 10, wherein the support member has a first face adjacent to and coplanar with the first face of the damper member.

12. The automotive vehicle of claim 11, wherein the damper member and the support member each define openings that are generally coaxial with the at least one opening in the flange body.

13. A method of assembling a pinion flange for an automotive vehicle, comprising:
forming a first opening in the pinion flange;
pressing a ring-shaped damper member into the first opening such that the damper member defines a second opening; and
pressing a ring-shaped support member into the second opening such that the damper member is adjacent to and between the support member and the first opening in the pinion flange.
